(19) United States
(12) Patent Application Publication
(10) Pub. No.: US 2024/0095674 A1
(43) Pub. Date: Mar. 21, 2024

(54) STORAGE-RETRIEVAL MANAGEMENT DEVICE, STORAGE-RETRIEVAL MANAGEMENT SYSTEM, AND STORAGE-RETRIEVAL MANAGEMENT METHOD

(71) Applicant: Panasonic Intellectual Property Management Co., Ltd., Osaka (JP)

(72) Inventors: Wataru SUDA, Osaka (JP); Taku KARIYAZAKI, Osaka (JP); Kazuhiro MOCHINAGA, Osaka (JP)

(21) Appl. No.: 18/546,573

(22) PCT Filed: Feb. 22, 2022
(86) PCT No.: PCT/JP2022/007100

§ 371 Date: Aug. 15, 2023

(30) Foreign Application Priority Data
Feb. 25, 2021 (JP) 2021-028414

(51) Int. Cl. G06Q 10/087; G06V 10/22

(52) U.S. Cl. CPC G06Q 10/087; G06V 10/225

(57) ABSTRACT

A storage-retrieval management device includes: an image capturer that captures images each including markers as subjects from above a refrigerator that includes a first storage structure and a second storage structure, the images showing a scene in which an object is put into or taken out of the refrigerator, the markers being provided on the first storage structure and the second storage structure, the second storage structure being at a position different from a position of the first storage structure in a vertical direction; and a determiner that determines a storage position at which the object is stored, based on whether the markers included in the images are visible or hidden.

### CROSS-REFERENCE OF RELATED APPLICATIONS

This application is the U.S. National Phase under 35 U.S.C. § 371 of International Patent Application No. PCT/JP2022/007100, filed on Feb. 22, 2022, which in turn claims the benefit of Japanese Patent Application No. 2021-028414, filed on Feb. 25, 2021, the entire disclosures of which applications are incorporated by reference herein.

### TECHNICAL FIELD

The present disclosure relates to a storage-retrieval management device, a storage-retrieval management system, and a storage-retrieval management method.

### BACKGROUND ART

Conventionally, technology that relates to a repository in which objects are stored has been proposed. Patent Literature (PTL) 1 discloses a storage-retrieval management system for refrigerators. The storage-retrieval management system disclosed in PTL 1 determines that objects are stored into or retrieved from a refrigerator using a learning model. The learning model outputs a result of storage/retrieval determination if information obtained by a sensor provided in the refrigerator is input.

### CITATION LIST

### Patent Literature

[PTL 1] Japanese Unexamined Patent Application Publication No. 2020-41761

### SUMMARY OF INVENTION

### Technical Problem

The present disclosure provides a storage-retrieval management device, a storage-retrieval management system, and a storage-retrieval management method with which storage positions in a repository at which objects are stored can be managed.

### Solution to Problem

A storage-retrieval management device according to an aspect of the present disclosure includes: an image capturer that captures images each including markers as subjects from above a repository that includes a first storage structure and a second storage structure, the images showing a scene in which an object is put into or taken out of the repository, the markers being provided on the first storage structure and the second storage structure, the second storage structure being at a position different from a position of the first storage structure in a vertical direction; and a determiner that determines a storage position at which the object is stored, based on whether the markers included in the images are visible or hidden.

A storage-retrieval management system according to an aspect of the present disclosure includes: an image capturer that captures images each including markers as subjects from above a repository that includes a first storage structure and a second storage structure, the images showing a scene in which an object is put into or taken out of the repository, the markers being provided on the first storage structure and the second storage structure, the second storage structure being at a position different from a position of the first storage structure in a vertical direction; and a determiner that determines a storage position at which the object is stored, based on whether the markers included in the images are visible or hidden.

A storage-retrieval management method according to an aspect of the present disclosure includes: capturing images each including markers as subjects from above a repository that includes a first storage structure and a second storage structure, the images showing a scene in which an object is put into or taken out of the repository, the markers being provided on the first storage structure and the second storage structure, the second storage structure being at a position different from a position of the first storage structure in a vertical direction; and determining a storage position at which the object is stored, based on whether the markers included in the images are visible or hidden.

### Advantageous Effects of Invention

A storage-retrieval management device, a storage-retrieval management system, and a storage-retrieval management method according to aspects of the present disclosure can manage storage positions in a repository at which objects are stored.

### BRIEF DESCRIPTION OF DRAWINGS

FIG. 1 is a block diagram illustrating a functional configuration of a storage-retrieval management system according to an embodiment.

FIG. 2 is an external view of a refrigerator and a storage-retrieval management device included in the storage-retrieval management system according to the embodiment.

FIG. 3 is a flowchart showing Operation Example 1 of the storage-retrieval management system according to the embodiment.

FIG. 4 illustrates an example of a video captured by an image capturer.

FIG. 5 illustrates an example of food management information.

FIG. 6 is a diagram for describing a determination method when food is stored onto an upper shelf.

FIG. 7 is a diagram for describing a determination method when food is stored onto a lower shelf.

FIG. 8 illustrates a video showing the refrigerator with a drawer in a pulled-out state, which is captured by the image capturer.

FIG. 9 is a sequence diagram of Operation Example 2 of the storage-retrieval management system according to the embodiment.

FIG. 10 illustrates an example of a display screen showing details of food management information.

FIG. 11 is a sequence diagram of Operation Example 3 of the storage-retrieval management system according to the embodiment.

FIG. 12 illustrates an example of a notification screen.

FIG. 13 is a block diagram illustrating a functional configuration of a storage-retrieval management system according to a variation.

FIG. 14 illustrates an example of setting region markers.

FIG. 15 illustrates a state in which food in a container is stored in a door compartment.

FIG. 16 is a first diagram illustrating a state in which doors are opened.

FIG. 17 is a second diagram illustrating a state in which the doors are opened.

FIG. 18 illustrates an example of setting information.

### DESCRIPTION OF EMBODIMENTS

The following gives a specific description of embodiments with reference to the drawings. Note that the embodiments described below each show a general or specific example. The numerical values, shapes, materials, elements, the arrangement and connection of the elements, steps, the processing order of the steps, and others indicated in the following embodiments are examples, and therefore are not intended to limit the present disclosure. Further, among the elements in the following embodiments, elements not recited in any of the independent claims are described as optional elements.

Note that the diagrams are schematic diagrams, and do not necessarily provide strict illustration. In the drawings, the same reference sign is given to a substantially same element, and a redundant description thereof may be omitted or simplified.

### Embodiment

### [Configuration]

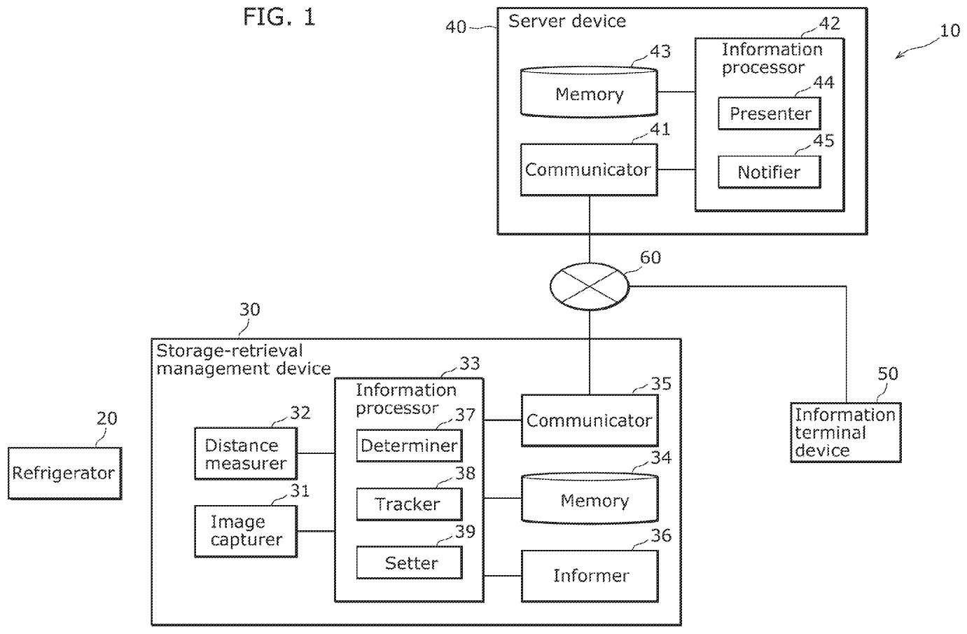

First, a configuration of a storage-retrieval management system according to an embodiment is to be described. FIG. 1 is a block diagram illustrating a functional configuration of the storage-retrieval management system according to the embodiment.

Storage-retrieval management system 10 illustrated in FIG. 1 is a system for managing food stored in refrigerator 20. Storage-retrieval management system 10 includes refrigerator 20, storage-retrieval management device 30, server device 40, and information terminal device 50.

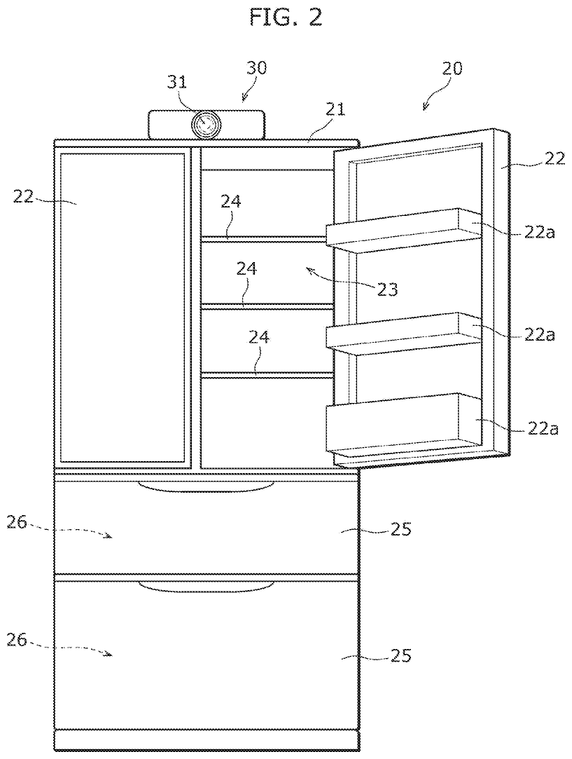

Refrigerator 20 is an example of a repository, and is provided in, for instance, a house of a user to refrigerate food. FIG. 2 is an external view of refrigerator 20 (and storage-retrieval management device 30). As illustrated in FIG. 2, refrigerator 20 includes main body 21, doors 22 for access to first storage space 23 inside main body 21, shelves 24 provided in first storage space 23, and drawers 25. By opening door(s) 22, refrigerator 20 is brought into a state in which food items can be placed on shelves 24 (that is, food can be stored in first storage space 23). Furthermore, by opening door(s) 22, refrigerator 20 is brought into a state in which food items can be stored in door compartments 22a provided inside of each door 22. By opening drawer 25, refrigerator 20 can be brought into a state in which food can be stored in second storage space 26 in drawer 25. In the example in FIG. 2, refrigerator 20 includes two doors 22 that cover first storage space 23, but nevertheless, single door 22 may cover first storage space 23.

Storage-retrieval management device 30 is attached onto, for example, a top surface of refrigerator 20, and performs information processing for managing food stored in refrigerator 20. Storage-retrieval management device 30 is retrofitted onto existing refrigerator 20, for example, but may be provided in refrigerator 20. Thus, storage-retrieval management device 30 may be a device separate from refrigerator 20, or may be a device manufactured integrally with refrigerator 20. As illustrated in FIG. 1, storage-retrieval management device 30 includes image capturer 31, distance measurer 32, information processor 33, memory 34, communicator 35, and informer 36.

Image capturer 31 captures, from above refrigerator 20, a video showing a scene in which food is put into or taken out of refrigerator 20. Thus, image capturer 31 captures, from above refrigerator 20, a video of refrigerator 20 with door(s) 22 in an open state, for example. The video includes, as subjects, doors 22, door compartments 22a, first storage space 23, shelves 24, drawers 25, and a floor of the room space in front of refrigerator 20. Image capturer 31 is implemented by, for example, a camera that includes a fisheye lens, but may be implemented by a camera that includes a normal lens.

Note that image capturer 31 may generate a plurality of images (still images) by capturing a scene in which an object is put into or taken out of refrigerator 20 at preset time intervals, and thus does not necessarily need to capture a video. Image capturer 31 is attached to a casing of storage-retrieval management device 30, but may be attached to refrigerator 20 apart from the casing of storage-retrieval management device 30. Thus, image capturer 31 may be retrofitted onto refrigerator 20. In this case, image capturer 31 may include a magnet, a suction cup, or a clip, for instance, as a structure with which image capturer 31 can be retrofitted onto refrigerator 20.

From above refrigerator 20, distance measurer 32 measures a distance from distance measurer 32 to each door 22. Thus, distance measurer 32 measures degrees to which doors 22 are opened. Distance measurer 32 is implemented by an infrared distance measurer sensor, for example. Distance measurer 32 can separately measure a distance from distance measurer 32 to right door 22 and a distance from distance measurer 32 to left door 22.

Note that as described later, distance measurer 32 is used to determine whether doors 22 are open or closed. Storage-retrieval management device 30 may include another sensor for determining whether doors 22 are open or closed, such as an angular sensor instead of distance measurer 32. A sensor for determining whether doors 22 are open or closed may be included in refrigerator 20, and in this case, storage-retrieval management device 30 may not include a sensor for determining whether doors 22 are open or closed.

Information processor 33 performs information processing for managing food stored in refrigerator 20. Information processor 33 is implemented by a microcomputer, for example, but may be implemented by a processor or a dedicated circuit. Information processor 33 includes determiner 37, tracker 38, and setter 39, as functional elements. Functions of determiner 37, tracker 38, and setter 39 are realized by, for example, the microcomputer included in information processor 33, for instance, executing a computer program stored in memory 34. Details of the functions of determiner 37, tracker 38, and setter 39 will be described later.

Memory 34 is a storage device that stores therein a computer program executed by information processor 33 and various information items necessary for the above-stated information processing (such as setting information and food management information described later). Memory 34 is implemented by a semiconductor memory, for example.

Communicator 35 is a communication circuit for storage-retrieval management device 30 to communicate with server device 40 via wide-area communication network 60. Communicator 35 is, for example, a wireless communication circuit that performs wireless communication, but may be a wired communication circuit that performs wired communication. A communication standard of the communication performed by communicator 35 is not particularly limited.

Informer 36 gives notice when a type of food put into and taken out of refrigerator 20 cannot be determined. Informer 36 is implemented by a loudspeaker or a buzzer, for instance, and gives notice by outputting sound, but may be implemented by a light emitting element such as a light emitting diode (LED) and may give notice by emitting light.

Server device 40 is a computer located outside of a building in which refrigerator 20 is placed, and is a cloud server, specifically. Server device 40 performs information processing for presenting information related to food stored in refrigerator 20. Server device 40 is an example of a notification device, and performs information processing for informing information related to food stored in refrigerator 20. Server device 40 includes communicator 41, information processor 42, and memory 43.

Communicator 41 is a communication circuit for server device 40 to communicate with storage-retrieval management device 30 and information terminal device 50 via wide-area communication network 60. Communicator 41 is, for example, a wired communication circuit that performs wired communication, but may be a wireless communication circuit that performs wireless communication. A communication standard of the communication performed by communicator 41 is not particularly limited.

Information processor 42 performs information processing for presenting or notifying information related to food stored in refrigerator 20. Information processor 42 is implemented by a microcomputer, for example, but may be implemented by a processor or a dedicated circuit. Information processor 42 includes presenter 44 and notifier 45, as functional elements. Functions of presenter 44 and notifier 45 are realized by, for example, the microcomputer included in information processor 42, for instance, executing a computer program stored in memory 43. Details of the functions of presenter 44 and notifier 45 will be described later.

Memory 43 is a storage device that stores therein a computer program executed by information processor 42 and various information items necessary for the above-stated information processing. Memory 43 is implemented by a semiconductor memory, for example.

Information terminal device 50 is possessed by the user. The user uses information terminal device 50 in order to receive notification from server device 40. Information terminal device 50 is a portable information terminal device such as a smartphone or a tablet terminal device, but may be a desktop information terminal device such as a personal computer.

### Operation Example 1

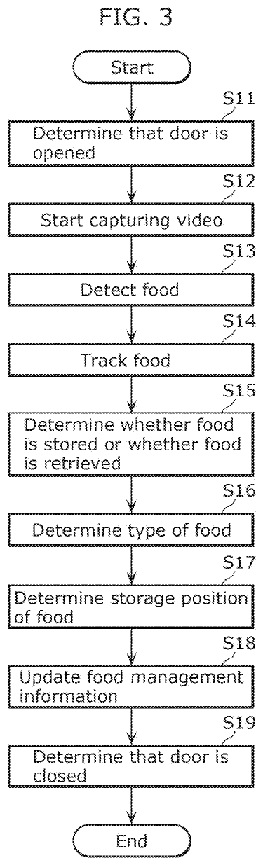

Next, operation for managing storage and retrieval of food is to be described as Operation Example 1 of storage-retrieval management system 10. FIG. 3 is a flowchart showing Operation Example 1 of storage-retrieval management system 10.

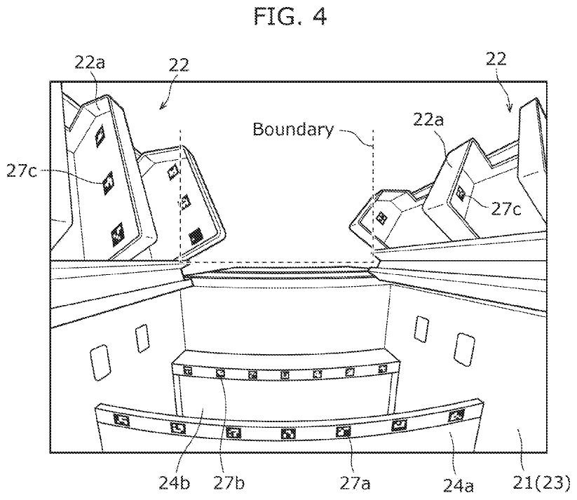

First, when determiner 37 determines that at least one of two doors 22 is opened, based on a result of measurement by distance measurer 32 (S11), image capturer 31 is activated and starts capturing a video (S12). FIG. 4 illustrates an example of a video captured by image capturer 31. As illustrated in FIG. 4, an image capturing area of image capturer 31 includes main body 21 (first storage space 23), inner sides of two doors 22 (door compartments 22a), and upper shelf 24a and lower shelf 24b provided in first storage space 23. Note that FIG. 4 also illustrates a boundary (a broken line) used to determine whether food is stored and whether food is retrieved. This boundary is not a line captured by image capturer 31, and is a virtual line.

Next, tracker 38 detects food captured in the video (S13), and tracks the detected food (S14). To detect food, various existing algorithms such as Regions with Convolution Neural Networks (R-CNN) are used. Tracker 38 detects food (hereinafter also referred to as a tracking target) also in a frame (also referred to as a current frame) that comes subsequent to a frame (hereinafter, also referred to as a previous frame) in which the food detected in step S13, for example, is captured. Tracker 38 determines, out of food items captured in the current frame, food at a position closest to a position of the tracking target in the previous frame, as the tracking target that has been moved. By repeating such processes, tracker 38 can track the food detected in step S13.

Note that tracker 38 may further extract an image feature amount of the food detected in step S13, and track the food using the image feature amount as auxiliary information. Tracker 38 may determine a moved position of the tracking target, based on, for example, a distance between the food detected in the current frame and the tracking target, and a similarity between the image feature amount detected in the current frame and that of the tracking target. Accordingly, the accuracy of tracking food can be improved.

Such a method for tracking food is an example, and another existing algorithm may be used to track food.

Next, determiner 37 determines whether food is stored or whether food is retrieved (S15). Determiner 37 determines that food being tracked is retrieved when the food is moved from refrigerator 20 to the indoor space beyond the boundary in the video. Determiner 37 determines that food that is a tracking target is stored when the food is moved from the indoor space to refrigerator 20 beyond the boundary in the video. Note that the boundary is predetermined empirically or experimentally.

Next, determiner 37 determines a type of the food that is stored or retrieved (S16). Determiner 37 determines a type of the food using a machine learning model, for example. Examples of types of food include a drink, a vegetable, and meat, for instance, but the types may be more finely classified. Note that the type of food may be determined at the same time when the food is detected in step S13, and in this case, step S16 can be omitted.

Next, determiner 37 determines a storage position at which food is stored (S17). As illustrated in FIG. 4, determiner 37 determines the storage position of food, based on whether first markers 27a, second markers 27b, and third markers 27c that are captured in the video are visible or hidden. First markers 27a are provided on upper shelf 24a, second markers 27b are provided on lower shelf 24b, and third markers 27c are provided on bottom portions of door compartments 22a. A method for determining the storage position of food in step S17 is to be described later in detail.

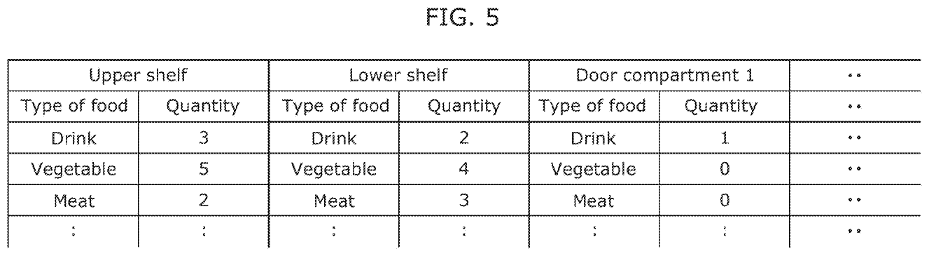

Next, determiner 37 updates food management information stored in memory 34, based on results of determinations in steps S15 to S17 (S18). FIG. 5 illustrates an example of food management information. The food management information shows a breakdown of food items stored in refrigerator 20. As illustrated in FIG. 5, the food management information shows types and quantities of food items at storage positions, for example. When determiner 37 determines that a drink is retrieved from upper shelf 24a in steps S15 to S17, determiner 37 decrements the quantity of drinks on upper shelf 24a in the food management information by one. Further, when determiner 37 determines that a vegetable is stored onto lower shelf 24b in steps S15 to S17, determiner 37 increments the quantity of vegetables on lower shelf 24b in the food management information by one.

After that, when determiner 37 determines that two doors 22 are both closed, based on the results of measurement by distance measurer 32 (S19), operation ends.

As described above, storage-retrieval management system 10 (storage-retrieval management device 30) can determine whether or not food captured in a video is stored into or retrieved from refrigerator 20 (whether food is stored into refrigerator 20 or whether food is retrieved from refrigerator 20), based on whether the food is moved beyond the boundary that is set.

Note that if determination of the type of food has failed in step S16, that is, when the type of food cannot be determined, determiner 37 may inform that determination of a type of food is impossible, using informer 36. For example, if informer 36 is implemented by a loudspeaker, informer 36 outputs an audio message, for instance, conveying that the type of food cannot be determined. If informer 36 is implemented by a light emitting element, informer 36 informs that the type of food cannot be determined, by emitting light.

In this manner, if the determination of a type of food has failed and that failure is informed, the user can cope with the failure by manually correcting the food management information.

### [Detail 1 of Method for Determining Storage Position]

Next, a method for determining a storage position at which food is stored in step S17 is to be described in detail. First, first markers 27a, second markers 27b, and third markers 27c are to be described.

First markers 27a are two-dimensional codes provided on the top surface of upper shelf 24a in first storage space 23. First markers 27a are aligned in the width direction of refrigerator 20, on a portion of shelf 24a closer to the user (a forward portion of refrigerator 20). Determiner 37 performs image processing on a video, and consequently can recognize first markers 27a as digital data. First markers 27a indicate digital data items different from one another, for example, but may indicate the same digital data item.

Second markers 27b are two-dimensional codes provided on the top surface of lower shelf 24b in first storage space 23. Second markers 27b are aligned in the width direction of refrigerator 20, on a portion of shelf 24b closer to the user (a forward portion of refrigerator 20). Determiner 37 performs image processing on a video, and consequently can recognize second markers 27b as digital data. Second markers 27b indicate digital data items different from one another, for example, but may indicate the same digital data item.

Third markers 27c are two-dimensional codes provided on the bottom portions of door compartments 22a. One third marker 27c may be provided on one door compartment 22a, or plural third markers 27c may be provided on one door compartment 22a. Determiner 37 performs image processing on a video, and consequently can recognize third markers 27c as digital data. Third markers 27c indicate digital data items different from one another, for example. For example, third markers 27c may indicate different digital data items for different doors 22. Thus, third markers 27c provided on right door 22 may indicate a different digital data item from the digital data item indicated by third markers 27c provided on left door 22. Third markers 27c may indicate different digital data items for different door compartments 22a.

Such arrangement of first markers 27a, second markers 27b, and third markers 27c is prestored in memory 34.

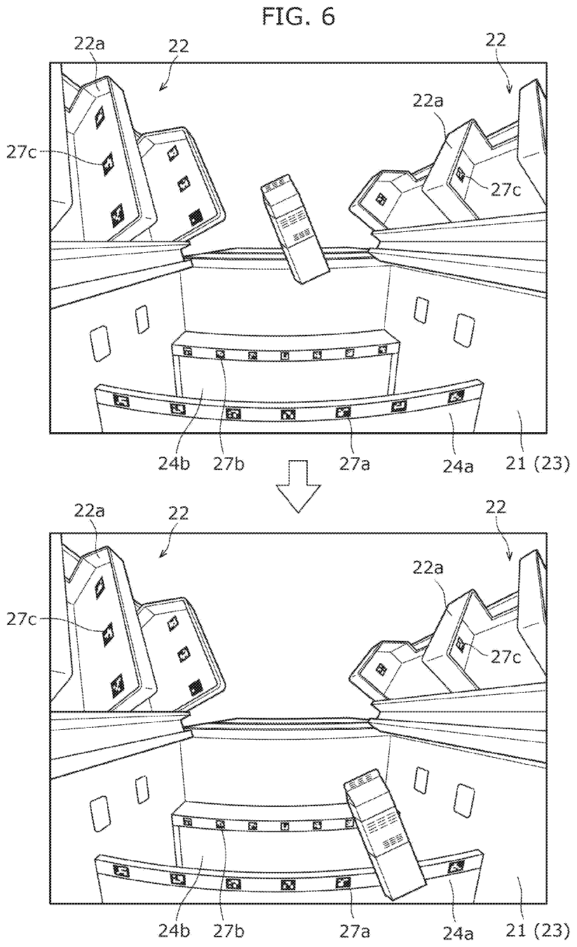

Next, a method for determining storage positions of food items, based on whether first markers 27a, second markers 27b, and third markers 27c are visible or hidden. FIG. 6 is a diagram for describing a determination method when food is stored onto upper shelf 24a. FIG. 6 illustrates a video captured by image capturer 31.

As illustrated in FIG. 6, when food is stored onto upper shelf 24a, at least one of first markers 27a provided on upper shelf 24a is at least temporarily hidden by the food and cannot be seen. Thus, when at least one first marker 27a is hidden when food is stored, determiner 37 determines that a storage position of the food is on shelf 24a. Even if first markers 27a are visible after the food is placed on shelf 24a, determiner 37 determines that a storage position of the stored food is on upper shelf 24a, based on at least one first marker 27a being made invisible while the food is stored thereonto. Determiner 37 determines that the storage position of the food is on shelf 24a when at least one first marker 27a is hidden, irrespective of whether one or more second markers 27b are hidden. Determiner 37 determines which region of upper shelf 24a includes a storage position of the food, based on which of first markers 27a is hidden.

Although not illustrated, the same applies to when food is retrieved from upper shelf 24a. If at least one first marker 27a is hidden when food is retrieved, determiner 37 determines that a storage position of the food is on shelf 24a. Determiner 37 determines that the storage position of the food retrieved was on upper shelf 24a, based on at least one first marker 27a being made invisible while the food is retrieved therefrom.

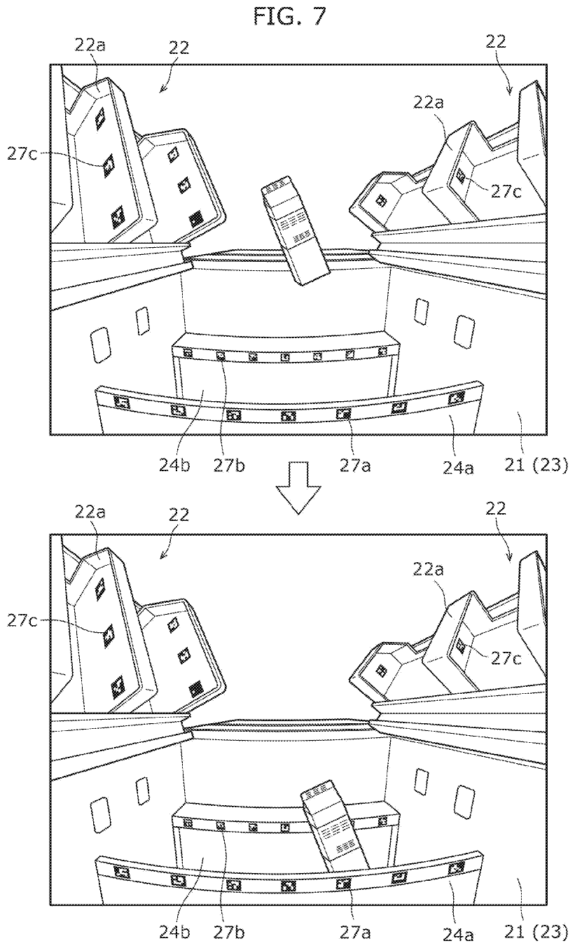

In contrast, FIG. 7 is a diagram for describing a determination method when food is stored onto lower shelf 24b. FIG. 7 illustrates a video captured by image capturer 31. As illustrated in FIG. 7, when food is stored onto lower shelf 24b, at least one of second markers 27b provided on lower shelf 24b is at least temporarily hidden by the food and cannot be seen while first markers 27a provided on upper shelf 24a remain visible. Thus, when first markers 27a remain visible and at least one second marker 27b is hidden when food is stored, determiner 37 determines that a storage position of the food is on shelf 24b. Even if second markers 27b are visible after the food is placed on shelf 24b, determiner 37 determines that a storage position of the stored food is on shelf 24b, based on at least one second marker 27b being made invisible while the food is stored thereonto. Determiner 37 determines which region of shelf 24b includes a storage position of the food, based on which of second markers 27b is hidden.

Although not illustrated, the same applies to when food is retrieved from lower shelf 24b. If first markers 27a remain visible and at least one second marker 27b is hidden when food is retrieved, determiner 37 determines that a storage position of the food is on shelf 24b. Determiner 37 determines that the storage position of the food retrieved was on shelf 24b, based on at least one second marker 27b being made invisible while the food is retrieved therefrom.

Next, a determination method when food items are stored into door compartments 22a is to be described. When food is stored into one of door compartments 22a, third marker 27c provided on the one of door compartments 22a is hidden and made invisible. Thus, if third marker 27c is hidden when food is stored, determiner 37 determines that a storage position of the stored food is on door compartment 22a provided with hidden third marker 27c. As described above, if third marker 27c indicates different digital data items for different doors 22 or for door compartments 22a, determiner 37 can determine the storage position of the food more accurately.

In contrast, if food is retrieved from one of door compartments 22a, third marker 27c provided on the one of door compartments 22a and made invisible by the food appears. Thus, if third marker 27c appears when the food is retrieved, determiner 37 determines that a storage position of the retrieved food was on door compartment 22a provided with third marker 27c that has appeared.

As described above, determiner 37 can determine the storage position of food, based on whether a marker is visible or hidden in a video. Specifically, determiner 37 can determine which one of shelf 24a, shelf 24b, or door compartment 22a includes the storage position of food.

Note that when a marker is made visible or hidden in an unexpected pattern, determiner 37 may fail to determine a storage position. In view of this, informer 36 may give notice when determination of the storage position of food in step S17 has failed. By giving such notice, the user can cope with the failure by manually correcting the food management information.

### [Detail 2 of Method for Determining Storage Position]

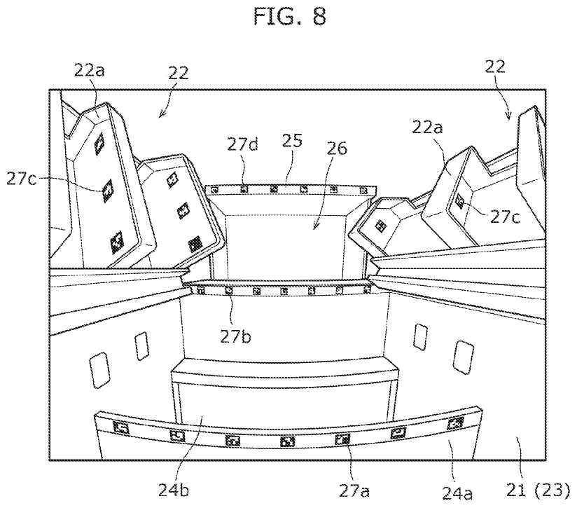

Determiner 37 can determine whether a storage position of food is in first storage space 23 covered with door 22 or second storage space 26 in drawer 25. FIG. 8 illustrates a video showing refrigerator 20 with drawer 25 in a pulled-out state, which is captured by image capturer 31.

As illustrated in FIG. 8, fourth markers 27d are two-dimensional codes provided on a top surface of a front panel of drawer 25. Fourth markers 27d are aligned in the width direction of refrigerator 20. Determiner 37 performs image processing on a video, and consequently can recognize fourth markers 27d as digital data. Fourth markers 27d indicate digital data items different from one another, for example, but may indicate the same digital data item.

Determiner 37 may determine in which of first storage space 23 or second storage space 26 a storage position of food is, based on whether such fourth markers 27d or second markers 27b are visible or hidden, for example. Note that a description of the determination method as below is given on the assumption that second markers 27b are provided on a bottom portion (more specifically, on a bottom surface) of first storage space 23. Second markers 27b may be provided close to the bottom portion of first storage space 23, and may be provided on shelf 24b similarly to the above description, for example.

For example, when food is stored into first storage space 23, at least one of second markers 27b provided on a bottom surface of first storage space 23 is at least temporarily hidden and made invisible by the food. Thus, when at least one second marker 27b is hidden when food is stored into, determiner 37 determines that a storage position of the food is in first storage space 23. Even if second markers 27b are visible after the food is stored into first storage space 23, determiner 37 determines that a storage position of the stored food is in first storage space 23, based on at least one second marker 27b being made invisible while the food is stored thereinto. Determiner 37 determines that the storage position of the food is in first storage space 23 when at least one second marker 27b is hidden, irrespective of whether one or more fourth markers 27d are hidden. Determiner 37 can determine (estimate) which region of first storage space 23 includes a storage position of food, based on which of second markers 27b is hidden.

Note that the same applies to the case where food is retrieved from first storage space 23. If at least one second marker 27b is hidden when food is retrieved, determiner 37 determines that a storage position of the food is in first storage space 23. Determiner 37 determines that the storage position of the food retrieved was in first storage space 23, based on at least one second marker 27b being made invisible while the food is retrieved therefrom.

In contrast, when food is stored into second storage space 26, at least one of fourth markers 27d is at least temporarily hidden and made invisible by the food while second markers 27b remain visible. Thus, when second markers 27b remain visible and at least one fourth marker 27d is hidden when food is stored, determiner 37 determines that a storage position of the food is in second storage space 26. Even if fourth markers 27d are visible after the food is stored into second storage space 26, determiner 37 determines that a storage position of the stored food is in second storage space 26, based on at least one fourth marker 27d being made invisible while the food is stored thereinto. Determiner 37 can determine (estimate) which region of second storage space 26 includes a storage position of food, based on which of fourth markers 27d is hidden.

Note that the same applies to the case where food is retrieved from second storage space 26. If second markers 27b remain unhidden and at least one fourth marker 27d is hidden when food is retrieved, determiner 37 determines that a storage position of the food is in second storage space 26. Determiner 37 determines that the storage position of the food retrieved was in second storage space 26, based on at least one fourth marker 27d being made invisible while the food is retrieved therefrom.

As described above, determiner 37 can determine in which one of first storage space 23 or second storage space 26 the storage position of food is, based on whether a marker is visible or hidden in a video.

### Operation Example 2

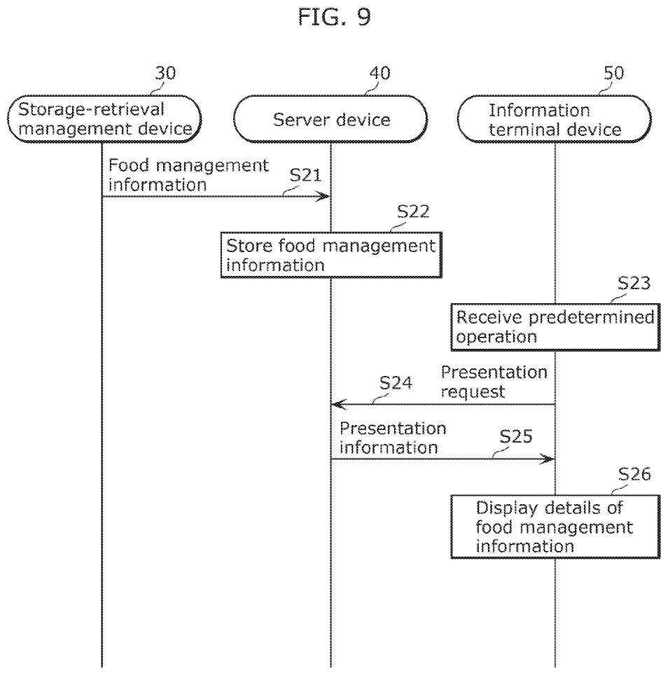

Next, as Operation Example 2 of storage-retrieval management system 10, operation for presenting food stored in refrigerator 20 is to be described. FIG. 9 is a sequence diagram of Operation Example 2 of storage-retrieval management system 10.

Communicator 35 of storage-retrieval management device 30 transmits food management information to server device 40 (S21). Communicator 41 of server device 40 receives the food management information, and presenter 44 stores the received food management information into memory 43 (S22). Communicator 35 of storage-retrieval management device 30 transmits food management information to server device 40 each time food storage determination or food retrieval determination is made, for example. Alternatively, communicator 35 of storage-retrieval management device 30 transmits food management information to server device 40 each time opened door 22 is closed. Accordingly, the updated food management information is stored into memory 43 of server device 40. Note that food management information may be transmitted from storage-retrieval management device 30 to server device 40 periodically, such as once in a predetermined time.

On the other hand, when the user performs, on information terminal device 50 from, for instance, a place away from home, a predetermined operation for checking food stored in refrigerator 20 (details of food management information), information terminal device 50 receives such a predetermined operation (S23), and transmits a presentation request to server device 40, based on the received predetermined operation (S24).

Communicator 41 of server device 40 receives the presentation request. Presenter 44 transmits, to information terminal device 50, presentation information for presenting details of the food management information stored in memory 43, based on the received presentation request (S25). More specifically, communicator 41 transmits the presentation information.

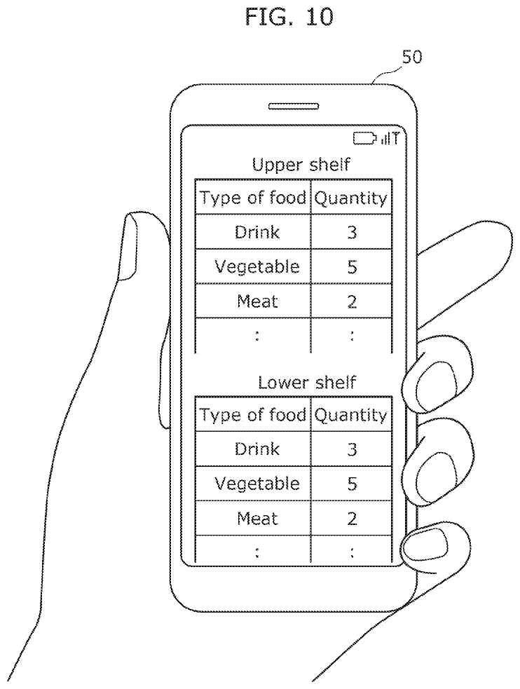

Information terminal device 50 receives the presentation information, and causes a display included in information terminal device 50 to show a display screen showing details of the food management information, based on the received presentation information (S26). FIG. 10 illustrates an example of a display screen showing details of food management information.

In this manner, the user of storage-retrieval management system 10 can check food stored in refrigerator 20 in the user's house from the place away from home, for instance.

### Operation Example 3

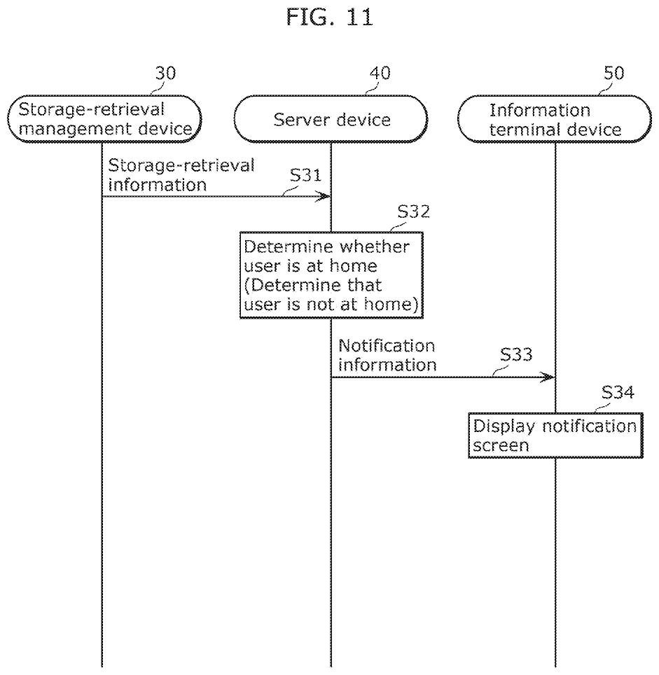

Next, as Operation Example 3 of storage-retrieval management system 10, an operation for notifying the user that food is stored into or retrieved from refrigerator 20 when the user is not at home is to be described. FIG. 11 is a sequence diagram of Operation Example 3 of storage-retrieval management system 10.

Communicator 35 of storage-retrieval management device 30 transmits storage-retrieval information to server device 40 each time food storage determination or food retrieval determination is made, for example (S31). Storage-retrieval information is an example of information indicating that food is put into or taken out of refrigerator 20.

Communicator 41 of server device 40 receives storage-retrieval information, and notifier 45 determines whether the user is at home (S32). Stated differently, notifier 45 determines whether storage-retrieval information is received during a period in which the user is not adjacent to refrigerator 20.

For example, information terminal device 50 includes a position measurer such as a Global Positioning System (GPS) module, and periodically transmits position information to server device 40. In this case, notifier 45 can determine whether the user is at home, based on the received position information. Note that the position (coordinates) of the user's house is registered in memory 43 in advance.

Instead of a method that uses position information, the user may report to server device 40 that the user is not at home by operating information terminal device 50. In this case, notifier 45 can regard execution of an away-from-home mode based on the above report as implying that the user is not at home.

When notifier 45 determines that the user is not at home, notifier 45 transmits notification information to information terminal device 50 (S33). More specifically, communicator 41 transmits notification information.

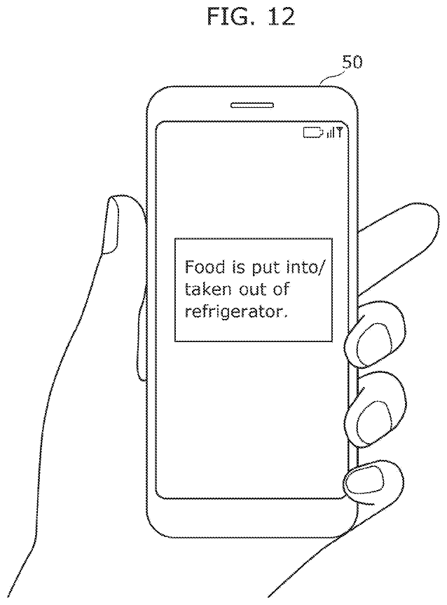

Information terminal device 50 receives the notification information, and displays a notification screen, based on the received notification information (S34). FIG. 12 illustrates an example of a notification screen. On the other hand, when notifier 45 has determined in step S32 that the user is at home (has not gone out), processing in steps S33 and S34 is not performed.

In this manner, storage-retrieval management system 10 notifies information terminal device 50 possessed by the user when storage-retrieval information indicating that an object is stored into refrigerator 20 or an object is retrieved from refrigerator 20 during a period in which the user is not adjacent to refrigerator 20.

Accordingly, the user can be aware that food is put into or taken out of refrigerator 20 during a period in which the user is not adjacent to refrigerator 20.

### [Variation 1]

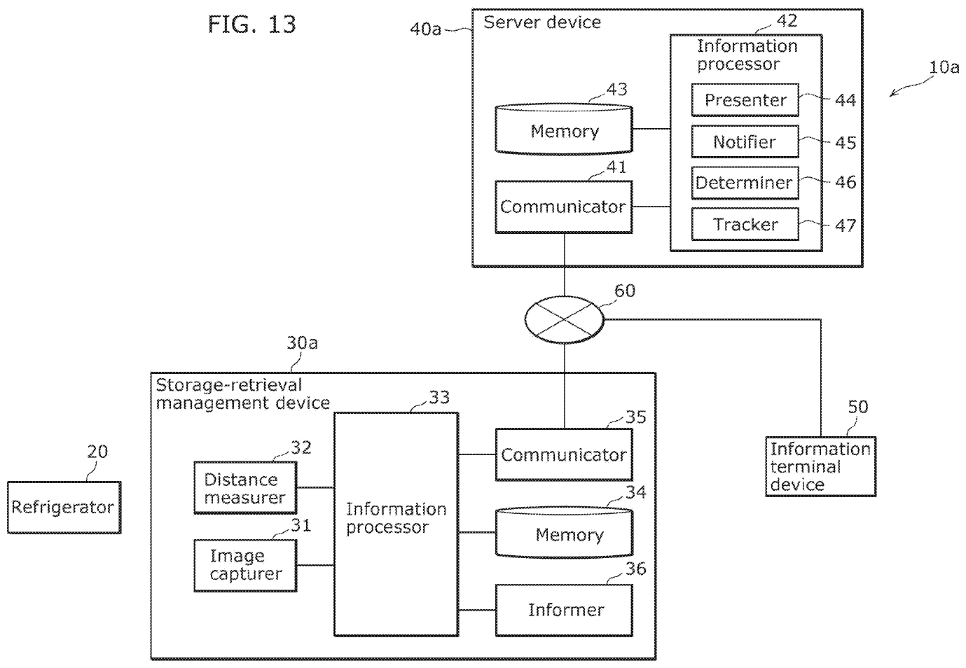

In the above embodiment, processing from detection of food (step S13) to update of food management information (step S18) is performed by storage-retrieval management device 30, but may be performed by server device 40. FIG. 13 is a block diagram illustrating a functional configuration of a storage-retrieval management system according to Variation 1.

As illustrated in FIG. 13, storage-retrieval management system 10a includes refrigerator 20, storage-retrieval management device 30a, server device 40a, and information terminal device 50. A difference from storage-retrieval management system 10 is that not storage-retrieval management device 30a, but server device 40a (more specifically, information processor 42) includes determiner 46 and tracker 47. Determiner 46 is an element having a substantially same function as that of determiner 37, whereas tracker 47 is an element having a substantially same function as that of tracker 38.

In such storage-retrieval management system 10a, server device 40a obtains, from storage-retrieval management device 30a, results of measurement by distance measurer 32 and videos captured by image capturer 31, for instance, to perform processing from detection of food (step S13) to update of food management information (step S18).

Note that part of the processing from detection of food (step S13) to update of food management information (step S18) may be performed by storage-retrieval management device 30a, and the remaining part thereof may be performed by server device 40a.

### [Variation 2]

In the above embodiment, the storage position of food in the vertical direction is determined, based on first markers 27a provided on shelf 24a, second markers 27b provided on shelf 24b, and fourth markers 27d provided on drawers 25. However, the storage position of food in the vertical direction may be determined, using an edge of shelf 24a, an edge of shelf 24b, and edges of drawers 25, instead of such markers. The edges here are the ones closer to openings of refrigerator 20 (edges closer to the user standing in front of refrigerator 20).

Edges can be detected (set) by setter 39 performing image processing on a video, for example. Any of existing algorithms may be used to detect edges. Furthermore, the user may set edges (more specifically, positions of pixels corresponding to edges in a video) after a positional relation between storage-retrieval management device 30 (image capturer 31) and refrigerator 20 is determined. In this case, for example, information terminal device 50 is used as a user interface. Note that a description has been given assuming that information terminal device 50 communicates with storage-retrieval management device 30 via wide-area communication network 60. Yet, information terminal device 50 may communicate with storage-retrieval management device 30 via a local communication network when information terminal device 50 is used as a user interface. Note that information processing with regard to detecting (setting) edges may be performed by setter 39.

A method for determining a storage position of food in the vertical direction using edges is similar to the method described in the above embodiment. The term “marker” in the above embodiment may be replaced with “edge” as appropriate.

Thus, storage-retrieval management device 30 includes: image capturer 31 that captures from above refrigerator 20 that includes a first storage structure and a second storage structure, images each including, as subjects, edges closer to an opening of refrigerator 20, the images showing a scene in which an object is put into or taken out of refrigerator 20, the edges being edges of the first storage structure and the second storage structure, the second storage structure being at a position different from a position of the first storage structure in a vertical direction; and determiner 37 that determines a storage position at which the object is stored, based on whether the edges included in the images are visible or hidden. Each of the first storage structure and the second storage structure is any of shelf 24a, shelf 24b, and drawer 25, for example.

Such storage-retrieval management device 30 can manage storage positions of objects in refrigerator 20.

### [Variation 3: Outline]

Storage-retrieval management system 10 (storage-retrieval management device 30) may set a boundary along contours of main body 21 and doors 22, and determine whether or not food captured in a video is stored into or retrieved from refrigerator 20 (whether food is stored into refrigerator 20 or whether food is retrieved from refrigerator 20), based on whether the food is moved beyond the boundary that is set. Storage-retrieval management system 10 can improve accuracy of determination as to whether food is stored into or retrieved from refrigerator 20, by setting a boundary along the contours of main body 21 and doors 22, as compared with the case where boundaries irrelevant to the contours are set. Storage-retrieval management system 10 can accurately determine storage of food into and retrieval of food from door compartments 22a, in particular. Note that the boundary is predetermined empirically or experimentally.

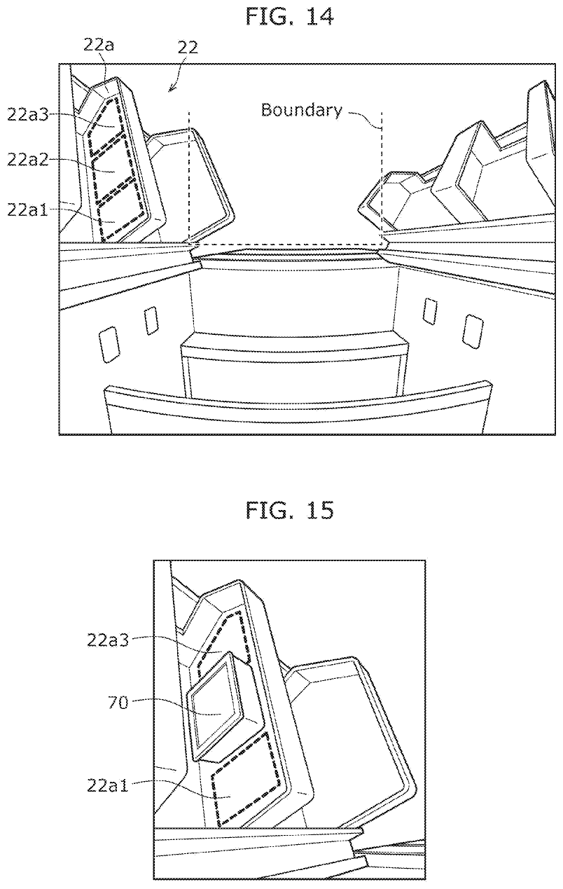

Similarly, storage-retrieval management system 10 (storage-retrieval management device 30) may set region markers 22a1, 22a2, and 22a3 that divide a bottom surface of door compartment 22a provided on the inner side of one of two doors 22 into predetermined regions in a video. FIG. 14 illustrates an example of setting region markers 22a1, 22a2, and 22a3. Note that FIG. 14 illustrates the case where the bottom portion of door compartment 22a is divided into three, but the present embodiment is not limited thereto.

Further, storage-retrieval management system 10 (storage-retrieval management device 30) can set in advance region markers 22a1, 22a2, and 22a3 that divide the bottom surface of door compartment 22a provided on the inner side of one of two doors 22 into predetermined regions, but the user can set such region markers. If the user sets the region markers, information terminal device 50, for example, may be used as a user interface. Note that a description has been given assuming that information terminal device 50 communicates with storage-retrieval management device 30 via wide-area communication network 60. Yet, information terminal device 50 may communicate with storage-retrieval management device 30 via a local communication network when information terminal device 50 is used as a user interface. Setter 39 performs information processing that relates to setting of region markers 22a1, 22a2, and 22a3. Note that region markers 22a1, 22a2, and 22a3 are not the ones captured by image capturer 31, but are virtual markers.

An operation example in which region markers 22a1, 22a2, and 22a3 are used is to be described below. Similarly to steps S11 and S12 in Operation Example 1, if determiner 37 determines that at least one of two doors 22 is opened, based on a result of measurement by distance measurer 32, image capturer 31 is activated and starts capturing a video. Here, distance measurer 32 is implemented by an infrared distance measurer sensor, for example. Distance measurer 32 can separately measure a distance from distance measurer 32 to right door 22 and a distance from distance measurer 32 to left door 22.

FIG. 14 described above illustrates an example of a video captured by image capturer 31, and as illustrated in FIG. 14, an image capturing area of image capturer 31 includes main body 21 (first storage space 23) and the inside of two doors 22 (door compartments 22a). FIG. 14 also illustrates a boundary (a broken line) used to determine whether food is stored into or retrieved from. This boundary is not the one captured by image capturer 31, but is a virtual line.

Next, similarly to step S17 in Operation Example 1, determiner 37 determines a storage position of food. As illustrated in FIG. 14, determiner 37 determines a storage position of food, based on whether region markers 22a1, 22a2, and 22a3 set on a bottom portion of door compartment 22a are visible or invisible (whether food overlaps at least one of the region markers), which is captured in a video.

FIG. 15 illustrates a state in which food 70 in a container is stored in door compartment 22a. Three region markers 22a1, 22a2, and 22a3 are set on a bottom surface of door compartment 22a, yet food 70 is stored therein, overlapping region marker 22a2. Determiner 37 can determine that food 70 is stored at a position of region marker 22a2, based on the state of a bottom portion of door compartment 22a captured in a video showing that region markers 22a1 and 22a3 are visible but region marker 22a2 is hidden.

### [Variation 3: Influence of Height of Food]

Note that in FIG. 15, food (not illustrated) placed on region marker 22a3 may not be seen in an image captured by image capturer 31, depending on the height of the food. However, as the opening angle of a door is decreased, the food placed on region marker 22a3 becomes visible. In view of this, determiner 37 may determine a storage position of food, at a plurality of opening angles of a door.

[Variation 3: Correction of Positions of Region Markers as Doors being Opened and Closed]

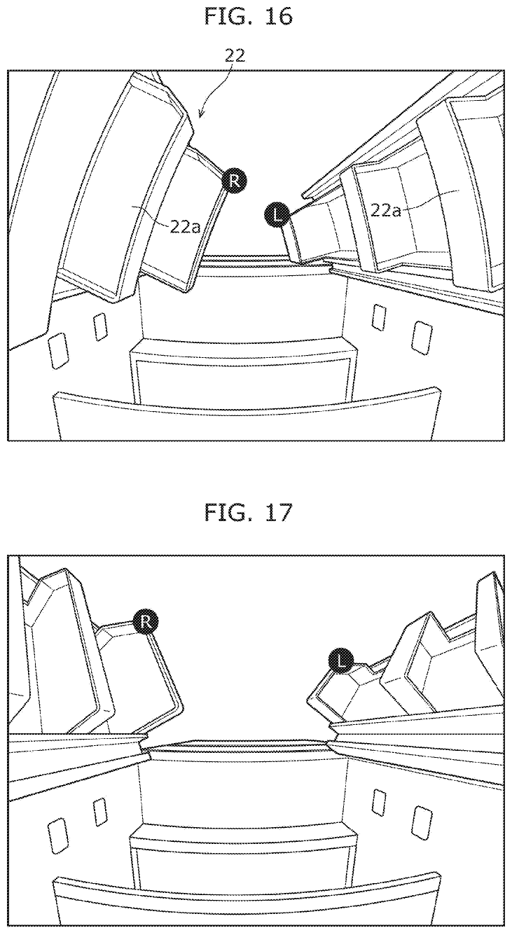

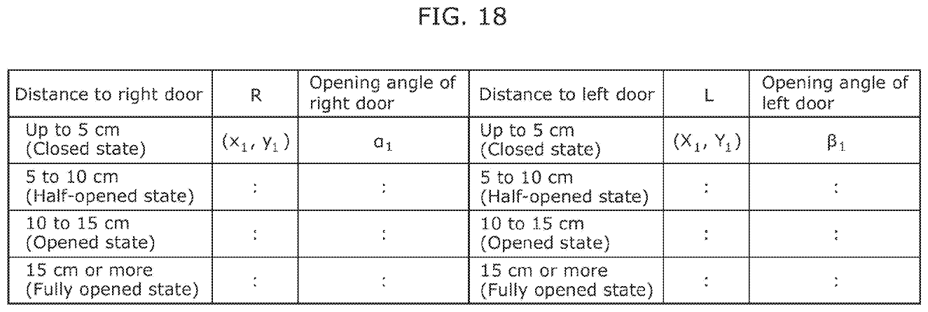

Setter 39 may dynamically change region markers 22a1, 22a2, and 22a3 according to degrees to which doors 22 are opened. FIG. 16 and FIG. 17 illustrate states in which doors 22 are opened. Here, the state illustrated in FIG. 17 shows that doors 22 are more widely opened than the state illustrated in FIG. 16. In this manner, for example, opening angles of left and right doors may be detected in order to dynamically change region markers 22a1, 22a2, and 22a3 according to degrees to which doors 22 are opened.

[Variation 3: Opening Angles of Doors being Measured by Distance Measurer]

For example, memory 34 prestores therein setting information for setting region markers. FIG. 18 illustrates an example of setting information. Numerical values in the setting information in FIG. 18 are temporary numerical values for explanation.

In the setting information in FIG. 18, a distance from distance measurer 32 to right door 22 and coordinates of point R provided on right door 22 are associated, and a distance from distance measurer 32 to left door 22 and coordinates of point L provided on left door 22 are associated. In the setting information, setter 39 can identify coordinates of points R and L that correspond to results of measurement by distance measurer 32, can determine opening angles of doors 22, based on the identified coordinates, and can set positions of region markers 22a1, 22a2, and 22a3 according to the opening angles of doors 22. Note that in the setting information in FIG. 18, the degrees to which doors 22 are opened are divided into four levels, but may be divided into five or more levels, or may be divided into three levels or less.

Note that in the present embodiment, one point R is provided on door 22 that is on the right when viewed from the user, and one point L is provided on door 22 that is on the left when viewed from the user. However, as long as the degrees to which doors 22 are opened can be identified, positions of points with which the degrees are to be measured and the number of such points may be determined as necessary.

[Variation 3: Opening Angles of Doors being Measured by Angular Sensor]

Alternatively, storage-retrieval management device 30 may include another sensor that measures degrees to which doors 22 are opened (opening angles), such as an angular sensor instead of distance measurer 32. A sensor for measuring degrees to which doors 22 are opened may be included in refrigerator 20, and in this case, storage-retrieval management device 30 may not include a sensor for measuring degrees to which doors 22 are opened.

As described above, setter 39 can set region markers 22a1, 22a2, and 22a3, using setting information, according to degrees to which doors 22 are opened. Note that for example, setter 39 obtains a mean value and variance of latest N measurement results (data items) (N is a natural number), and adopts the mean value as a valid distance only when the variance is a predetermined value or less.

### [Other Variations]

In the above embodiments, refrigerator 20 may be a refrigerator for a typical household or may be a refrigerator for product display that is used in a shop such as a convenience store or may be a refrigerator for other business use.

In addition, if food items of a single type are stored in refrigerator 20, the type of the food items may not be determined.

Refrigerator 20 is an example of a repository, and the present disclosure can be implemented as other repositories that do not have a cooling function. In addition, items (in other words, objects) stored in a repository are not limited to food, and may be other items. The case where items other than food are stored in refrigerator 20 can also be conceived.

### ADVANTAGEOUS EFFECTS

As described above, storage-retrieval management device 30 includes: image capturer 31 that captures images each including markers as subjects from above refrigerator 20 that includes a first storage structure and a second storage structure, the images showing a scene in which an object is put into or taken out of refrigerator 20, the markers being provided on the first storage structure and the second storage structure, the second storage structure being at a position different from a position of the first storage structure in a vertical direction; and determiner 37 that determines a storage position at which the object is stored, based on whether the markers included in the images are visible or hidden. Each of the first storage structure and the second storage structure is any of a shelf, a drawer, or a door compartment, for example. Specifically, the markers include first markers 27a, second markers 27b, third markers 27c, and fourth markers 27d, for instance. Refrigerator 20 is an example of a repository.

Such storage-retrieval management device 30 can manage storage positions of objects in refrigerator 20.

For example, the first storage structure and the second storage structure are shelves (for example, shelf 24a and shelf 24b) provided in a same storage space (for example, first storage space 23). Determiner 37 determines in which one of shelf 24a or shelf 24b the storage position of the object is, based on whether the markers in the images are visible or hidden.

Such storage-retrieval management device 30 can manage whether a storage position of an object in refrigerator 20 is on shelf 24a or shelf 24b.

For example, the first storage structure defines first storage space 23, the second storage structure defines second storage space 26 at a position different from a position of first storage space 23 in the vertical direction. Determiner 37 determines in which one of first storage space 23 or second storage space 26 the storage position of the object is, based on whether the markers in the images are visible or hidden.

Such storage-retrieval management device 30 can manage whether a storage position of an object in refrigerator 20 is in first storage space 23 or second storage space 26.

For example, the first storage structure and the second storage structure are door compartments 22a provided in door 22 included in refrigerator 20.

Such storage-retrieval management device 30 can manage whether a storage position of an object in refrigerator 20 is in first storage space 23 or second storage space 26.

For example, the position of the first storage structure is above the position of the second storage structure. Determiner 37 determines that the storage position of the object corresponds to the position of the first storage structure when, out of the markers, a marker provided on the first storage structure is hidden in at least one of the images. Determiner 37 determines that the storage position of the object corresponds to the position of the second storage structure when the marker provided on the first storage structure is not hidden and, out of the markers, a marker provided on the second storage structure is hidden in at least one of the images.

Such storage-retrieval management device 30 can manage storage positions of objects in refrigerator 20.

The first storage structure is provided with at least two markers out of the markers, and the second storage structure is provided with at least two markers out of the markers.

Such storage-retrieval management device 30 can manage in more detail a storage position of an object, based on which of the markers is hidden.

For example, determiner 37 further determines a type of the object. Storage-retrieval management device 30 further includes: informer 36 that gives notice when the type of the object is indeterminable.

With such notice from storage-retrieval management device 30, the user can cope with the case by manually correcting the food management information.

For example, image capturer 31 includes a structure with which image capturer 31 is retrofittable onto refrigerator 20.

Such image capturer 31 can be retrofitted onto refrigerator 20.

Storage-retrieval management system 10 includes: storage-retrieval management device 30; and server device 40. Server device 40 includes: communicator 41 that receives, from storage-retrieval management device 30, storage-retrieval information indicating that the object is stored into or retrieved from refrigerator 20; and notifier 45 that notifies information terminal device 50 possessed by a user of refrigerator 20 when the storage-retrieval information is received during a period in which the user is not adjacent to refrigerator 20.

With the notice from such storage-retrieval management system 10, the user can be aware that food is put into or taken out of refrigerator 20 during a period in which the user is not adjacent to refrigerator 20.

Storage-retrieval management system 10 includes: image capturer 31 that captures images each including markers as subjects from above refrigerator 20 that includes a first storage structure and a second storage structure, the images showing a scene in which an object is put into or taken out of refrigerator 20, the markers being provided on the first storage structure and the second storage structure, the second storage structure being at a position different from a position of the first storage structure in a vertical direction; and determiner 37 that determines a storage position at which the object is stored, based on whether the markers included in the images are visible or hidden. As with storage-retrieval management system 10a, determiner 37 may be included in server device 40a.

Such storage-retrieval management system 10 can manage storage positions of objects in refrigerator 20.

A storage-retrieval management method executed by a computer such as storage-retrieval management system 10 includes: capturing images each including markers as subjects from above refrigerator 20 that includes a first storage structure and a second storage structure, the images showing a scene in which an object is put into or taken out of refrigerator 20, the markers being provided on the first storage structure and the second storage structure, the second storage structure being at a position different from a position of the first storage structure in a vertical direction; and determining a storage position at which the object is stored, based on whether the markers included in the images are visible or hidden.

With such a storage-retrieval management method, storage positions of objects in refrigerator 20 can be managed.

### Other Embodiments

Although the above has described embodiments, the present disclosure is not limited to the above embodiments.

For example, the above embodiments have described that a marker is a two-dimensional code, yet the marker does not need to be a two-dimensional code, but may be a graphic or a line that extends in the width direction of a refrigerator. Further, a pattern for another use (for example, a pattern made by a groove provided in a shelf) provided in the refrigerator may be used as a marker. A specific aspect of a marker is not limited in particular.

A method for providing a storage structure with a marker is not limited in particular. For example, a marker may be provided onto a storage structure by sticking onto the storage structure a sticker on which the marker is printed. Accordingly, the storage-retrieval management system can manage objects stored in a repository (refrigerator) onto which a marker is not originally provided.

In the embodiments above, the storage-retrieval management system is implemented by a plurality of devices, but may be implemented by a single device. For example, the storage-retrieval management system may be implemented as a single device corresponding to the storage-retrieval management device according to the above embodiment, or may be implemented by a single device corresponding to a server device. When the storage-retrieval management system is implemented by a plurality of devices, how elements included in the storage-retrieval management system are distributed among the plurality of devices is not specifically determined.

For example, a method for communication between devices in the above embodiments is not limited in particular. In the communication between devices, a relay device not illustrated may be provided between the devices. A path for information transmission described in the above embodiment is not limited to the transmission paths illustrated in the sequence diagrams.

For example, in the above embodiment, processing executed by a particular processor may be executed by another processor. The order of processes may be changed or plural processes may be executed in parallel.

In the above embodiments, each of the elements may be implemented by executing a software program suitable for the element. Each element may be implemented by a program executor such as a CPU or a processor reading and executing a software program recorded on a recording medium such as a hard disk or semiconductor memory.

Further, each element may be implemented by hardware. For example, each element may be a circuit (or an integrated circuit). The circuits may constitute one circuit as a whole or may be separate circuits. These circuits may be general-purpose circuits or dedicated circuits.

General and specific aspects of the present disclosure may be implemented using a system, a device, a method, an integrated circuit, a computer program, or a computer-readable recording medium such as a CD-ROM. The general and specific aspects of the present disclosure may be implemented using any combination of systems, devices, methods, integrated circuits, computer programs, and recording media.

For example, the present disclosure may be implemented as an object storage-retrieval management method executed by a computer, or may be implemented as a program for causing a computer to execute the storage-retrieval management method. The present disclosure may be implemented as a non-transitory computer-readable recording medium having such a program recorded thereon.

The present disclosure also encompasses embodiments resulting from applying various modifications, which may be conceived by those skilled in the art, to the embodiments, and other embodiments resulting from combining elements and functions in the embodiments, without departing from the gist of the present disclosure.

### REFERENCE SIGNS LIST

10, 10a storage-retrieval management system
20 refrigerator (repository)
21 main body
22 door
22a door compartment
23 first storage space
24 shelf
24a upper shelf
24b lower shelf
26 second storage space
27a first marker
27b second marker
27c third marker
27d fourth marker
30, 30a storage-retrieval management device
31 image capturer
32 distance measurer
33, 42 information processor
34, 43 memory
35, 41 communicator
36 informer
37, 46 determiner
38, 47 tracker
39 setter
40, 40a server device (notification device)
44 presenter
45 notifier
50 information terminal device
60 wide-area communication network

1. A storage-retrieval management device comprising:
an image capturer that captures images each including markers as subjects from above a repository that includes a first storage structure and a second storage structure, the images showing a scene in which an object is put into or taken out of the repository, the markers being provided on the first storage structure and the second storage structure, the second storage structure being at a position different from a position of the first storage structure in a vertical direction; and
a determiner that determines a storage position at which the object is stored, based on whether the markers included in the images are visible or hidden,
wherein the first storage structure and the second storage structure are door compartments provided in a door included in the repository, and
the markers include region markers in the images, the region markers being set by dividing, into predetermined regions, a bottom surface of at least one of the door compartments that are the first storage structure and the second storage structure.

2. The storage-retrieval management device according to claim 1,
wherein
the determiner determines on which of the region markers structure the storage position of the object is, based on whether the region markers in the images are visible or hidden in the at least one of the door compartments in which the region markers are set.

3. The storage-retrieval management device according to claim 1,
wherein the first storage structure defines a first storage space,
the second storage structure defines a second storage space at a position different from a position of the first storage space in the vertical direction, and
the determiner determines in which one of the first storage space or the second storage space the storage position of the object is, based on whether the markers in the images are visible or hidden.

4. (canceled)

5. The storage-retrieval management device according to claim 1,
wherein the position of the first storage structure is above the position of the second storage structure,
the determiner determines that the storage position of the object corresponds to the position of the first storage structure when, out of the markers, a marker provided on the first storage structure is hidden in at least one of the images, and
the determiner determines that the storage position of the object corresponds to the position of the second storage structure when the marker provided on the first storage structure is not hidden and, out of the markers, a marker provided on the second storage structure is hidden in at least one of the images.

6. (canceled)

7. The storage-retrieval management device according to claim 1,
wherein the determiner further determines a type of the object, and
the storage-retrieval management device further comprises:
an informer that gives notice when the type of the object is indeterminable.

8. (canceled)

9. (canceled)

10. A storage-retrieval management system comprising:
the storage-retrieval management device according to claim 1; and
a notification device,
wherein the notification device includes:
a communicator that receives, from the storage-retrieval management device,
information indicating that the object is stored into or retrieved from the repository; and
a notifier that notifies an information terminal device possessed by a user of the repository when the information is received during a period in which the user is not adjacent to the repository.

11. A storage-retrieval management system comprising:
an image capturer that captures images each including markers as subjects from above a repository that includes a first storage structure and a second storage structure, the images showing a scene in which an object is put into or taken out of the repository, the markers being provided on the first storage structure and the second storage structure, the second storage structure being at a position different from a position of the first storage structure in a vertical direction; and
a determiner that determines a storage position at which the object is stored, based on whether the markers included in the images are visible or hidden,
wherein the first storage structure and the second storage structure are door compartments provided in a door included in the repository, and
the markers include region markers in the images, the region markers being set by dividing, into predetermined regions, a bottom surface of at least one of the door compartments that are the first storage structure and the second storage structure.

12. A storage-retrieval management method comprising:
capturing images each including markers as subjects from above a repository that includes a first storage structure and a second storage structure, the images showing a scene in which an object is put into or taken out of the repository, the markers being provided on the first storage structure and the second storage structure, the second storage structure being at a position different from a position of the first storage structure in a vertical direction; and
determining a storage position at which the object is stored, based on whether the markers included in the images are visible or hidden,
wherein the first storage structure and the second storage structure are door compartments provided in a door included in the repository, and
the markers include region markers in the images, the region markers being set by dividing, into predetermined regions, a bottom surface of at least one of the door compartments that are the first storage structure and the second storage structure.

13. A non-transitory computer-readable recording medium having recorded thereon a program for causing a computer to execute the storage-retrieval management method according to claim 12.

14. The storage-retrieval management device according to claim 1,
wherein the region markers are changeable according to an opening angle of the door, and
the determiner determines the storage position of the object with use of the region markers set according to the opening angle of the door.

15. The storage-retrieval management device according to claim 14, further comprising:
a distance measurer that measures a distance from the distance measurer to the door,
wherein the opening angle of the door is determined with use of the distance measured by the distance measurer, and
the determiner determines the storage position of the object with use of the region markers set according to the opening angle of the door that is determined.

16. The storage-retrieval management device according to claim 15, further comprising:
a setter that sets the region markers,
wherein the setter determines a distance for use in determining the opening angle of the door, by using results of the distance measurer measuring the distance from the distance measurer to the door a predetermined number of times.

17. The storage-retrieval management device according to claim 14, further comprising:
a sensor that measures the opening angle of the door,
wherein the determiner determines the storage position of the object with use of the region markers set according to the opening angle of the door measured by the sensor.
